(19) United States
(12) Patent Application Publication
(10) Pub. No.: US 2024/0308569 A1
(43) Pub. Date: Sep. 19, 2024

(54) Steering System

(71) Applicant: Mercedes-Benz Group AG, Stuttgart (DE)

(72) Inventors: Torsten SCHADT, Boeblingen (DE); Christian BORN, Hamburg (DE); Joachim CURRLE, Stuttgart (DE)

(21) Appl. No.: 18/578,992

(22) PCT Filed: Jun. 23, 2022
(86) PCT No.: PCT/EP2022/067081

§ 371 Date: Jan. 12, 2024

(30) Foreign Application Priority Data
Jul. 13, 2021 (DE) 10 2021 003 606.9

(51) Int. Cl. B62D 1/06; B60H 1/00

(52) U.S. Cl. CPC B62D 1/065; B60H 1/00292

(57) ABSTRACT

A steering system for a motor vehicle includes a steering wheel, a front hollow-cylindrical steering shaft, and a rear hollow-cylindrical steering shaft. The front hollow-cylindrical steering shaft is connected with the steering wheel at one longitudinal end and with the rear hollow-cylindrical steering shaft at another longitudinal end. The steering system additionally has an air conditioning unit with a cavity system and an air duct. The cavity system is formed in the steering wheel and is connected with the air duct in an air-conducting manner. The air duct is partially formed by the hollow space in the rear hollow-cylindrical steering shaft and a hollow space in the front hollow-cylindrical steering shaft.

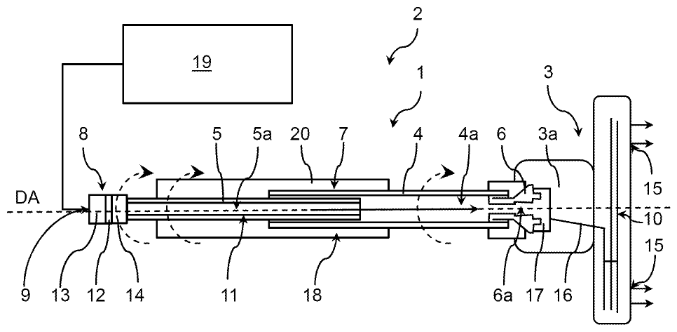

### BACKGROUND AND SUMMARY OF THE INVENTION

The invention relates to a steering system for a motor vehicle. The invention also relates to the motor vehicle with the steering system.

A steering system with an air-conditioned steering wheel is known, for example, from DE 298 15 623 U1. The air-conditioned steering wheel reduces perspiration on the hands of the driver and thus improves the feeling of comfort at higher temperatures and/or over long journeys.

A device for ventilating steering wheels is known from DE 20 2004 014 968 U1, preferably by the influx of temperature-controlled air in the gripping area and the following discharge of the air through a large number of outlet openings distributed in the gripping area.

A control element in a car having a hollow grip section, which can be gripped by an occupant, with air outlet openings to which air is guided through an air guiding duct and flows out through the air outlet openings into the passenger compartment, is known from DE 197 35 834 A1.

Furthermore, a steering wheel that can be ventilated and heated from inside is known from DE 24 58 643 A1. Additionally, a multifunctional steering wheel is disclosed in WO 2005/123 483 A1 which can regulate its own temperature by cooling and heating its surface.

Furthermore, DE 298 15 623 U1 discloses an air conditioning security steering wheel for cooling/ventilating the hands in motor vehicles of all types, wherein air is injected from the climate control system or a common ventilation blower into the region of the steering column cover through a hose connection.

For air conditioning the steering wheel, a porous outlet structure is formed in the steering wheel for the outflow of air. This outlet structure can be connected with the climate control system of the motor vehicle in an air-conducting manner which provides dry and cool air. For this purpose, common air-conducting hoses are led into the steering system and connected with the porous outlet structure in the steering wheel in an air-conducting manner. Disadvantageously, the air-conducting hoses are twisted when the steering wheel is turned, whereby there is a high risk of them being crushed. With large steering angles, air gaps can also occur at the connection points, which lead to undesirable noise being produced in the steering system.

Alternatively, a separate air conditioning system with a blower and a Peltier element can be integrated in the steering wheel. Disadvantageously, the warmth from the Peltier element is counter productively released into the passenger compartment and the blower causes undesired noise to be produced by sucking in and conveying air. Furthermore, separate air conditioning systems of this type have a large space requirement.

The object of the invention, therefore, is to specify an improved or at least alternative embodiment for a steering system of the generic type and for a motor vehicle with the steering system, in which embodiment the described disadvantages are resolved.

The present invention is based on the general concept of using already existing hollow spaces in a steering system for guiding conditioned air to a steering wheel. A steering system is provided for a motor vehicle. The steering system has a steering wheel, a front hollow-cylindrical steering shaft, and a rear hollow-cylindrical steering shaft. Thus, the front steering shaft is connected with the steering wheel at one longitudinal end and with the rear steering shaft at another longitudinal end for conjoint rotation in each case. The steering system also has an air conditioning unit with a cavity system for air conditioning the steering wheel and with an air duct for supplying conditioned air to the cavity system. The cavity system is formed in the steering wheel and is connected with the air duct in an air-conducting manner. According to the invention, the air duct of the air conditioning unit is partially formed by a hollow space in the rear steering shaft and a hollow space in the front steering shaft.

Furthermore, it is provided that the steering system has an air supply for providing conditioned air. The air supply is connected with the hollow space of the rear steering shaft at a longitudinal end of the rear steering shaft, opposite a steering wheel, in an air-conducting manner. The air supply is accordingly arranged on the longitudinal end of the rear steering shaft, opposite the steering wheel.

Furthermore, it is provided that the air conditioning unit has a sealing system and the sealing system connects the air supply with the longitudinal end of the rear steering shaft, opposite to the steering wheel, rotatably and in an airtight manner. The sealing system thus seals the hollow space in the rear steering shaft airtight to the outside so that the air duct inside the steering shaft remains free from engine-side dirt.

In addition, it is provided that the sealing system has a seal, an air-supply-side element, and a steering-shaft-side element. The air supply is formed in the air-supply-side element and the steering-shaft-side element is connected in an airtight manner with the longitudinal end of the rear steering shaft, opposite the steering wheel, for conjoint rotation. The air-supply-side element and the steering-shaft-side element are connected with each other rotatably and in an airtight manner via the seal. The seal can be a metal seal and/or a labyrinth seal and/or a polymer seal.

The seal enables the steering-shaft-side element to twist in relation to the air supply in the air-supply-side element. On twisting of the rear steering shaft, the steering-shaft-side element can therefore be twisted on the air-supply-side element, whereby the connection between the two elements remains sealed by the seal. The air-supply-side element and the air supply formed in the air-supply-side element can be installed rotationally fixed or stationary in the motor vehicle. If additional hoses or tubes are arranged on the air supply for the climate control system or the separate air conditioning system, these can also be installed rotationally fixed or stationary in the motor vehicle. Thus, damage to the hoses or the tubes can be avoided.

The hollow space in the front steering shaft and the hollow space in the rear steering shaft can each be formed in the centre The hollow space in the front steering shaft and the hollow space in the rear steering shaft can each extend coaxially to a rotational axis of the steering system. The hollow space in the rear steering shaft can merge into the hollow space in the front steering shaft. The front steering shaft and the rear steering shaft can be metallic. A longitudinal central axis of the front steering shaft can coincide with the rotational axis. A longitudinal central axis of the rear steering shaft can coincide with the rotational axis. The front steering shaft and the rear steering shaft can be aligned coaxially to each other.

Advantageously, the rear steering shaft and the front steering shaft can be connected with each other in a shift region so that they can be shifted along the rotational axis. In the shift region, the rear steering shaft, at its longitudinal end facing the steering wheel, can be partially received in the front steering shaft or in the hollow space of the front steering shaft. In the shift region, the front steering shaft and the rear steering shaft are connected in an airtight manner to the outside. The rear steering shaft and/or the front steering shaft can be received in a vehicle-side housing so as to rotate around the rotational axis. The vehicle-side housing can be arranged rotationally fixed and/or stationary in the motor vehicle.

In the steering system according to the invention, the air conditioning of the steering wheel can be easily achieved. In particular, the air duct is partially achieved by the already existing hollow spaces in the steering shaft so that a complex guiding of air into the steering wheel can be dispensed with. In addition, a relative movement of the steering wheel does not affect the air duct, whereby the danger of crushing the air duct is reduced.

Thus, the air supply can be designed to connect with a climate control system of the motor vehicle. The climate control system of the motor vehicle can provide conditioned air for air conditioning the steering wheel. The climate control system can be used for cooling and heating air for the air conditioning unit, as well as for pressure build-up in the air duct. The air supply can be connected with the climate control system in an air-conducting manner via additional hoses or additional tubes. Here, an additional blower in the passenger compartment can be dispensed with, whereby less noise is produced in the vehicle interior. Furthermore, it does not need any expensive Peltier elements.

Alternatively, the air supply can be designed to connect with a separate air conditioning system with a blower and, if necessary, a Peltier element. The air supply can be connected with the blower in an air-conducting manner via additional hoses or additional tubes. The air conditioning system can thus be arranged on the rear steering shaft opposite the steering wheel and thus in the engine compartment of the motor vehicle. In other words, the air conditioning system can be arranged on the engine compartment side. Therefore, the noise produced by the blower and the heat caused by the Peltier element in the passenger compartment can be reduced.

Advantageously, it can be provided that the steering wheel is connected with the front steering shaft via a hollow-cylindrical central screw for conjoint rotation. The hollow space in the front steering shaft merges into the hollow space in the central screw. The air duct of the air conditioning unit is partially formed by the hollow space in the central screw.

The cavity system is connected in an air-conducting manner with the hollow space of the central screw via a flexible end conduit. Preferably, the flexible end conduit is formed by a flexible end hose. The air duct in the steering system can then be formed by the hollow space of the rear steering shaft, the hollow space of the front steering shaft, the hollow space of the central screw and the flexible end conduit. The end conduit can be attached to the central screw by means of a screw connection. For this purpose, the end conduit has a screw cuff with an inner screw thread and the central screw has an outer screw thread. As the central screw, together with the steering wheel and thus together with the end conduit, is pivoted when steering, the steering wheel, the central screw, and the end conduit do not rotate relative to each other. Thus, the risk of crushing the air-conducting end conduit is excluded.

Advantageously, it can be provided that the cavity system has a plurality of flow-through openings, and the openings are formed in the steering wheel. The openings are thus connected with the air duct in an air-conducting manner and lead out of the steering wheel to the outside. The plurality of openings can be formed by cavities and/or ridges in a foam forming the steering wheel and/or by holes in a porous functional mat of the steering wheel and/or in a perforated cover layer of the steering wheel. Conditioned air can then flow out of the air duct into the cavities and/or ridges of the foam and be distributed in the steering wheel. From the foam of the steering wheel, the air can then flow out via the porous functional mat and/or via the perforated cover layer. The cover layer can, for example, be moulded from leather or artificial leather and have a perforation.

In a development of the steering system, it can be provided that the steering system has at least one force feedback actuator for laterally introducing the simulated steering forces via a gearbox. Alternatively, the steering system can have at least one force feedback actuator which is installed radially in relation to the front steering shaft and/or radially in relation to the rear steering shaft. Thus, simulated steering forces can be laterally introduced in the steering system. In other words, the force feedback actuator is connected in a Z-Y block instead of in an X block.

The invention also relates to a motor vehicle with a steering system and a climate control system. The steering system has an air conditioning unit with a cavity system for air conditioning the steering wheel and with an air duct for supplying conditioned air to the cavity system. The cavity system is formed in the steering wheel and is connected with the air duct in an air-conducting manner. According to the invention, the steering system is formed as described above. Thus, the air duct of the air conditioning unit is connected in an air-conducting manner with the climate control system and the conditioned air for the air conditioning unit can be delivered via the climate control system. In order to avoid repetitions, reference is made at this point to the above comments for the steering system.

### BRIEF DESCRIPTION OF THE DRAWING

A preferred exemplary embodiment of the invention is represented in the drawing and is explained in closer detail in the following description.

### DETAILED DESCRIPTION OF THE DRAWING

The single FIGURE shows a steering system 1 according to the invention in a vehicle 2. The steering system 1 has a steering wheel 3 which is rotatable around a rotational axis DA, a front hollow-cylindrical steering shaft 4 and a rear hollow-cylindrical steering shaft 5. The steering wheel 3 is connected at its steering wheel cap 3a with the front steering shaft 4 by means of a central screw 6 for conjoint rotation. In a shift region 7 of the steering system 1, the front steering shaft 4 is connected, facing away from the steering wheel 3, with the rear steering shaft 5 so as to be displaceable along the rotational axis DA and for conjoint rotation. When the steering wheel 3 is turned, the front steering shaft 4 and the rear steering shaft 5 also rotate with it.

In the shift region 7, the front steering shaft 4 and the rear steering shaft 5 are displaced in and out of each other along the rotational axis DA and therefore a driver dependent adjustment of the steering wheel 3 is conducted. The shift region 7 is airtight to the outside. In addition, the steering system 1 has a sealing system 8 which is arranged on the rear steering shaft 5 facing away from the steering wheel 3 and seals the rear steering shaft 5.

The steering system 1 has an air conditioning unit 18. The air conditioning unit comprises an air supply 9, a cavity system 10 and an air duct 11. The air supply 9 is formed in the sealing system 8 and the cavity system 10 is formed in the steering wheel 3. The air duct 11 connects the air supply 9 and the cavity system 10 with each other in an air-conducting manner.

The sealing system 8 has a seal 12, an air-supply-side element 13 and a steering-shaft-side element 14. The steering-shaft-side element 14 is connected in an airtight manner with the rear steering shaft 5 opposite the steering wheel 3 for conjoint rotation. The air-supply-side element 13 is connected in an airtight manner with the steering-shaft-side element 14 via the seal 12 for conjoint rotation. The cavity system 10 has multiple flow-through openings 15, formed in the steering wheel 3.

The air duct 11 connects the air supply 9 in the sealing system 8 with the cavity system 10 in the steering wheel 3. The air duct 11 is formed by a hollow space 5a of the rear steering shaft 5, a hollow space 4a of the front steering shaft 4, a hollow space 6a of the central screw 6 and an end conduit 16. The end conduit 16 connects the cavity system 10 with the hollow space 6a of the central screw 6.

The end conduit 16 is fastened with the central screw 6. For this, the end conduit 16 has a screw cuff 17 with an inner screw thread and the central screw 6 has an outer screw thread. In the steering system 1, the end conduit 16 can be rotated with the steering wheel 3 and with the front steering shaft 4, such that rotation of the end conduit 16 relative to the steering wheel 3 does not occur.

The steering system 1 is arranged in the motor vehicle 2 in the FIGURE. The motor vehicle 2 has a climate control system 19 and a housing 20 for the steering system 1. The climate control system 19 is connected with the air supply 9 of the air conditioning unit 18 in an air-conducting manner and provides conditioned air for the air conditioning unit 18. The conditioned air can be conveyed from the climate control system 19 to the air supply 9 and further through the air duct 11 to the steering wheel 3. Then the conditioned air can exit from the steering wheel 3 and the steering wheel 3 is air conditioned. Therefore, the feeling of comfort of the driver is improved at high temperatures and/or during long journeys.

The steering wheel 3, the front steering shaft 4, the rear steering shaft 5 and the steering-shaft-side element 14 are rotationally fixed relative to each other. The air-supply-side element 13 is fixed to the vehicle and is not rotatable relative to the motor vehicle 2. The housing 20 is fixed to the vehicle and rotatably receives the steering system 1 in the region of the steering shafts 4 and 5 or of the shift region 7. In the steering system 1 installed in the vehicle 2, the steering wheel 3, the front steering shaft 4, the rear steering shaft 5 and the steering-shaft-side element 14 are rotationally fixed relative to each other and can rotate relative to the vehicle 2 and the air-supply-side element 13.

In the steering system 1 according to the invention, the steering wheel 3 can be air conditioned by the air conditioning unit 19 in a simplified manner. In this case, conditioned air can be conveyed from the air supply 9 via the already existing hollow spaces 4a, 5a and 6a and end conduit 16 into the cavity system 10 and to the outside via the openings 15 of the cavity system 10. In addition, a relative rotation of the steering wheel 3 does not affect the air duct 11 and in particular the end conduit 16, whereby the danger of crushing the air duct is reduced.

1.-7. (canceled)

8. A steering system (1) for a motor vehicle (2), comprising:
a steering wheel (3);
a front hollow-cylindrical steering shaft (4);
a rear hollow-cylindrical steering shaft (5);
wherein the front hollow-cylindrical steering shaft (4) is connected with the steering wheel (3) at a first longitudinal end and with the rear hollow-cylindrical steering shaft (5) at a second longitudinal end;
an air conditioning unit (18) with a cavity system (10) for air conditioning the steering wheel (3) and with an air duct (11) for supplying conditioned air to the cavity system (10);
wherein the cavity system (10) is formed in the steering wheel (3) and is connected with the air duct (11) in an air-conducting manner;
wherein the air duct (11) is partially formed by a hollow space (5a) in the rear hollow-cylindrical steering shaft (5) and a hollow space (4a) in the front hollow-cylindrical steering shaft (4); and
an air supply (9) for delivering the conditioned air, wherein the air supply (9) is connected with the hollow space (5a) in the rear hollow-cylindrical steering shaft (5) at a longitudinal end of the rear hollow-cylindrical steering shaft (5) which is opposite the steering wheel (3) in an air-conducting manner;
wherein the air conditioning unit (18) has a sealing system (8) that connects the air supply (9) to the longitudinal end of the rear hollow-cylindrical steering shaft (5) rotatably and in an airtight manner;
wherein the sealing system (8) has a seal (12), an air-supply-side element (13), and a steering-shaft-side element (14);
wherein the air supply (9) is formed in the air-supply-side element (13);
wherein the steering-shaft-side element (14) is connected in an airtight manner with the longitudinal end of the rear hollow-cylindrical steering shaft (5);
wherein the air-supply-side element (13) and the steering-shaft-side element (14) are connected with each other rotatably and in an airtight manner via the seal (12).

9. The steering system (1) according to claim 8, wherein the seal (12) is a metal seal or a labyrinth seal or a polymer seal.

10. The steering system (1) according to claim 8:
wherein the steering wheel (3) is connected with the front hollow-cylindrical steering shaft (4) via a hollow-cylindrical central screw (6);
wherein the hollow space (4a) in the front hollow-cylindrical steering shaft (4) merges into a hollow space (6a) in the hollow-cylindrical central screw (6);
wherein the air duct (11) of the air conditioning unit (18) is partially formed by the hollow space (6a) in the hollow-cylindrical central screw (6).

11. The steering system (1) according to claim 10, wherein the cavity system (10) is connected in an air-conducting manner with the hollow space (6a) in the hollow-cylindrical central screw (6) via a flexible end conduit (16).

12. The steering system (1) according to claim 8:
wherein the cavity system (10) has a plurality of flow-through openings (15) and wherein the plurality of flow-through openings (15) are formed in the steering wheel (3);
wherein the plurality of flow-through openings (15) are connected in an air-conducting manner with the air duct (11) and lead out of the steering wheel (3).

13. The steering system (1) according to claim 8, further comprising a force feedback actuator for laterally introducing a simulated steering force via a gearbox.

14. The steering system (1) according to claim 8, further comprising a force feedback actuator, wherein the force feedback actuator is installed radially in relation to the front hollow-cylindrical steering shaft (4) or radially in relation to the rear hollow-cylindrical steering shaft (5).

15. A motor vehicle (2), comprising:
the steering system (1) according to claim 8; and
a climate control system (19);
wherein the air duct (11) of the air conditioning unit (18) is connected with the climate control system (19) in an air-conducting manner and the conditioned air for the air conditioning unit (18) is deliverable by the climate control system (19).
